(19) United States
(12) Patent Application Publication
(10) Pub. No.: US 2002/0025100 A1
(43) Pub. Date: Feb. 28, 2002

(54) Method and apparatus for OPTO-electronic built-in tests

(75) Inventors: Emmanuelle Laprise, Montreal (CA); David V. Plant, Montreal (CA)

Correspondence Address: OGILVY RENAULT, 1981 MCGILL COLLEGE AVENUE, SUITE 1600, MONTREAL, QC, H3A2Y3, CA

(73) Assignee: McGILL UNIVERSITY

(21) Appl. No.: 09/881,055

(22) Filed: Jun. 15, 2001

Related U.S. Application Data
(60) Provisional application No. 60/211,963, filed on Jun. 16, 2000.

(51) Int. Cl. G02B 6/12

(52) U.S. Cl. 385/14

(57) ABSTRACT

A method and circuitry is provided to adapt VLSI built-in testing and self-testing to opto-electronic VLSI technology. This method facilitates the testing of lasers, laser drivers, receivers and photodiodes by extending the concepts of scan-chain testing and BER testing. The advantages of this method are most obvious for opto-electronic ASICs that have a large number of VCSELs arranged in a regular fashion, such as an array or a line. Quantitative and qualitative testing is performed with variations to the circuitry.

### CROSS-REFERENCE TO RELATED APPLICATIONS

The present application claims priority of US Provisional Patent Applications serial number 60/211,963 filed Jun. 16, 2000 and Ser. No. 60/252,130 filed Nov. 28, 2000.

The invention was made under a contract with the US Army Research Laboratory ALC, contract number DAAL01-98-C-0074 and the United States Government has rights herein.

### FIELD OF THE INVENTION

The present invention relates to a method and apparatus for adapting normal Very Large Scale Integration (VLSI) testing approaches to the testing of opto-electronic VLSI circuit elements and, more particularly, to opto-electronic built-in tests and built-in self tests.

### BACKGROUND OF THE INVENTION

An opto-electronic (OE) chip contains electrical as well as optical inputs and outputs. This allows the transmission of data through electrical and optical paths. A transmitter (TX) performs an electrical-to-optical transformation of data and transmits the data to a receiver (RX). At the receiver end, an optical-to-electrical transformation is executed to render the data processable by the electrical circuitry present on the chip. A move towards OE is advantageous for the increased speed of transmissions and the greater bandwidth available with this type of technology. It is possible to have two chips communicating with each other without any cumbersome electrical interconnects. This type of inter-chip communication is leading to many new application developments in the fields of telecommunications and photonics.

Large arrays of VLSI emitters, such as Vertical Cavity Surface Emitting Lasers (VCSELs), and photodiodes (PD), are currently being tested in a fast and automated process prior to hybridization. However, it has now become necessary to perform automated tests on-chip, as large arrays of these types of elements are being integrated into applications within the OE-VLSI technology. The transmitters and receivers present on chip are only complete after the hybridization process. Therefore, new testing must be done as post-hybridization testing includes testing the CMOS chip and the OE devices.

There are currently several existing methods for the testing of large arrays of transmitters and receivers. The first is to test each TX/IRX individually, which is extremely time-consuming. Another method of testing for large arrays of TX/IRX is to use a probe card, as is done when testing a chip prior to hybridization. The problem with using a probe card is that an array of hybridized circuits requires a very different amount of current to be provided to the circuit to be tested than a pre-hybridized chip does. With prior art device technologies, a probe card cannot handle the required current. Furthermore, probe cards are designed in such a way that they connect to all pads on the chip simultaneously. This blocks access to where the optical input/output (I/O) goes on and off the chip.

The Very Large Scale Integration (VLSI) aspect of OE is a relatively new area of technology. For this reason, tests for large arrays of receivers and transmitters are not yet developed. Linear Feedback Shift Registers (LFSR), such as signature registers, are often used to automate tests for combinational circuits. Such testing is not done for opto-electronic VLSI circuits. Tests specifically for large scale arrays of transistors and receivers are not found in the prior art.

### SUMMARY OF THE INVENTION

The present invention is directed to the testing of opto-electronic VLSI circuits. It provides a method and on-chip circuitry for testing large arrays of optically coupled transmitters and/or receivers on integrated circuit chips. A combination of electrical and optical inputs and/or outputs are present on the chips.

Accordingly, an object of the present invention is to provide tests that can be used to quantify the performance of the transmitters (laser driver and laser) and receivers (PD, pre-amplifier, post-amplifier, filter, and clock/data recover) in large arrays of OE-VLSI devices. This type of testing can occur at a number of levels, such as basic functional testing (i.e. pass/fail testing), functional testing which produces a mapping of the transceiver functionality as a function of position in the array, and “at-speed” testing which tests performance at target optical interconnect data rates.

Also, another object of the present invention is to provide circuitry that will allow data to be generated and validated on-chip, removing the limitations imposed by the bond pads in generating a wide test data stream at a very high speed. This would make it possible to verify simultaneously that all of the optical elements of a chip are working correctly. This method can be used to circumvent bottlenecks associated with injecting and/or extracting electrical data to and from the substrate, respectively, due to narrow, low speed electrical data I/0 paths for the testing of OE-VLSI circuitry.

Another object of the present invention is to provide a test pattern on a large array of optical elements with a reduced number of inputs, where the number of inputs is less than the number of elements to be tested. The test data can be input in a serial manner or in a parallel manner.

Another object of the present invention is to provide scan chain circuitry that allows serial input of control signals to a set of optical elements that are to be tested. The control signals can take the form of different patterns of test vectors that allow for simple visual inspection of faulty emitters For example, a checkerboard pattern is an ideal visual test because a laser malfunction disrupts the pattern, thereby indicating a fault.

Also, another object of the present invention is to provide addressing that allows the ability to address single elements or groups of elements. For example, a group of elements could comprise of every alternate cell of a row or column, such as in a checkerboard pattern. A single element can be addressed by sending in a single “1” bit through the scan chain. However, to provide a checkerboard pattern, a test vector such as 101010 can be scanned through.

In accordance with a first aspect of the present invention, there is provided a method for performing built-in tests and built-in self-tests for large arrays of optically coupled transmitters and receivers on integrated circuit chips, where the testing and self-testing of transmitter-receiver pairs is done in parallel and test data for all pairs is read out in a highly reduced manner. The testing circuitry is built on, for example, silicon ASIC, comprises OE input/output ports, and an optical path is provided between each transmitter-receiver pair. The transmitters and receivers being tested may be on the same chip or, in some cases, on different chips. The method also comprises generating test data on chip, transmitting the test data through an optical path from TX to RX, receiving the test data at the receiver, and validating the test data on-chip. It is also possible to send the test data to be processed off-chip.

In accordance with a second aspect of the present invention, there is provided a method for direct addressing of a particular cell or a group of cells. For example, an N×M array of elements is arranged in a matrix configuration where each element is identified by its row and column address (NI, Mj). Each individual element can then be addressed by ANDing two control signals that correspond to the row and column addresses, respectively, of the element, of course this requires N+M control inputs. It would also be feasible to generate the N control inputs and M control inputs from one or more scan chains.

As an alternative to individual element addressing and scan chain testing, the present invention provides for division of a matrix of emitters into pattern groups, each of which is controllable by a single control signal. For example, if a rectangular matrix is divided into 3×3 element blocks, each element of each block can be controlled by a single one of the control signals. This allows for a single control signal to test emitters from each block spaced apart from any other active emitters and can facilitate visual inspection of the array being tested. After testing each of the nine (9) elements in each block, the testing is complete. Furthermore, a fault that results in cross-talk or leakage from one element to an adjacent element can also be easily detected.

In accordance with a third aspect of the present invention, there is provided a circuit for built-in tests and self-tests for large arrays of optically coupled transmitters and receivers on integrated circuit chips comprising an array of linear feedback shift registers to input data to transmitters, an optical path for data to be transmitted from TX to RX, a comparator to compare input and output data, and an accumulator to accumulate errors detected by the comparator.

In accordance with a forth aspect of the present invention, there is provided a circuit for built-in tests and self-tests for large arrays of optically coupled transmitters and receivers on integrated circuit chips comprising selection circuitry to select a TX-RX pair, an optical path for data to be transmitted from TX to RX, and Bit Error Rate (BER) testing circuitry to detect Bit Error Rate performance.

The optical interconnect between transmitters and receivers, for intra-chip and inter-chip testing, can be done using an optical probe card. The card is lowered onto the chip(s) within close enough distance to provide an optical path from TX to RX. A card that connects element (i, j) from an array of transmitters to element (i, j) from an array of receivers performs a first test for the transceiver pair. If an error is detected amongst a transceiver pair, it is initially impossible to tell which of the transmitter or receiver is defective. However, the malfunctioning device can be identified specifically by providing an optical path between element (i, j) and element (i+1, j+1) if it has been previously determined that the transmitter (i+1, j+1) and receiver (i+1, j+1) pair is functioning properly. This can be done using two or more probe cards. When the faulty element is identified, it is then possible to map around it when designing circuitry.

As well as testing that is done on a one-to-one basis, it is possible to test and identify defects or errors for an entire array at once and be capable of pinpointing the exact transceiver pair that produced the error. By sending a known test pattern from an array of transmitters to an array of receivers, the pattern can be identified at the output of the receivers as being the original pattern or not. For example, if a checkerboard pattern is transmitted, it is possible to identify a disruption in the pattern. The faulty pair can be located with respect to the location of the error in the checkerboard pattern and its respective location in the array being tested. Another easily identifiable pattern is an array consisting of all 1's. A disruption in the pattern can easily be identified at the output of the receivers and the faulty pair immediately identified. The above method with the use of the probe card can then be used to determine which of the two elements that form the pair is the faulty one.

### BRIEF DESCRIPTION OF THE DRAWINGS

These and other features, aspects and advantages of the present invention will become better understood with regard to the following description and accompanying drawings wherein:

FIG. 1 is a schematic diagram of circuitry for the built-in test and self-test using a comparator and an accumulator.

FIG. 2 is the optical interconnection of transmitters and receivers when they are on the same chip.

FIG. 3 is the optical interconnection of transmitters and receivers when they are not on the same chip.

FIG. 4 is a schematic diagram of circuitry for the built-in test and self-test using Bit Error Rate testing circuitry.

FIG. 5 illustrates a top view of a hybridized CMOS chip as well as a schematic view of the components necessary to test an array of emitters;

FIG. 6 illustrates a schematic view of a preferred embodiment for testing emitters, where D flip flops are part of the original circuitry;

FIG. 7 is a schematic of the inside of a scan D flip flop;

FIG. 8 is a schematic view of an alternate embodiment for testing emitters, where D flip-flops are not part of the original circuitry; and

FIG. 9 illustrates a schematic view of an alternate embodiment for testing emitters, where a pair of scan chains are used to control a two dimensional array of emitters.

### DETAILED DESCRIPTION OF THE PREFERRED EMBODIMENT

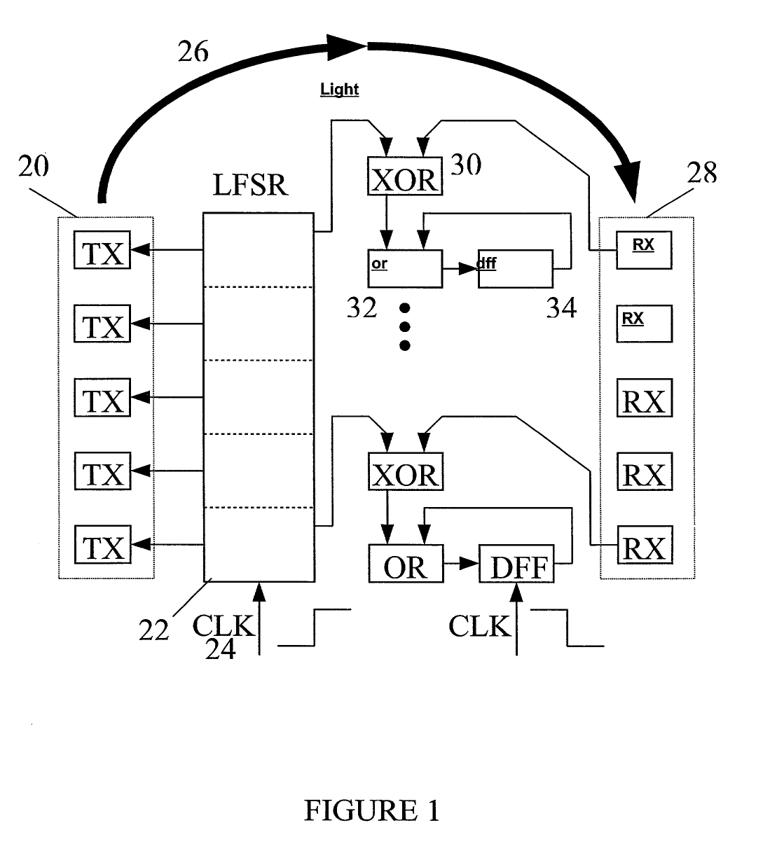

FIG. 1 illustrates the circuit setup for a preferred embodiment of a built-in test or self-test. Data is first clocked 24 into an array of linear feedback shift registers (LFSR) 22. Once all the test data has been entered, the LFSR is then connected to a string of DFFs that directly feed the transmitters 20. The data is then sent to the receivers via light 26, or other type of optical medium and received by the receivers 28. The EXCLUSIVE-OR gate 30 serves as a comparator between the data initially stored in the LFSR and the data received at the receivers. If the two are the same, a 0 is sent to the OR gate 32 and stored in the D flip-flop (DFF) 34. If the two differ, then a 1 is sent to the OR gate 32 and consequentially stored in the DFF 34. The 1 remains in the closed loop formed by the DFF 34 and OR gate 32, indicating that an error has been detected.

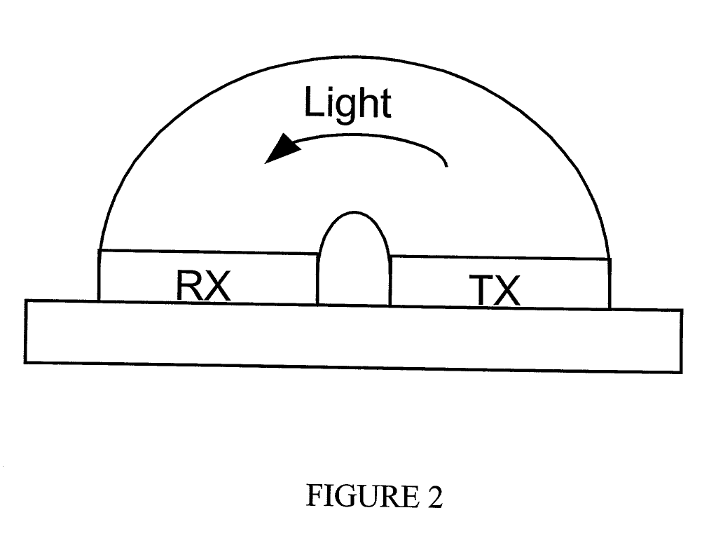

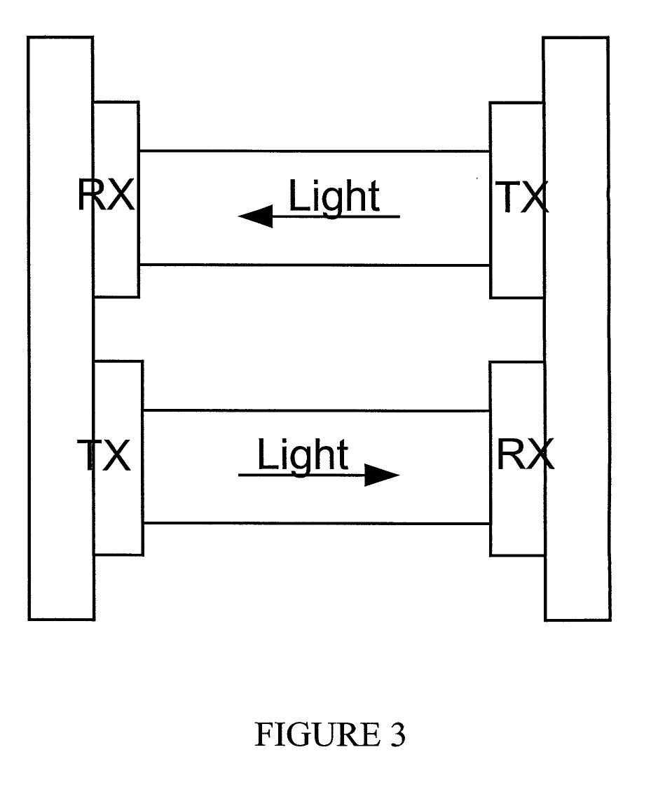

One advantage of this method is that it makes it possible to verify simultaneously that all of the optical elements are working correctly. This circuitry is ideal for basic functional testing of transceiver pairs. Data can be generated and validated on-chip. Many opto-electronic chips have both receiver and transmitter arrays. FIG. 2 illustrates how these can be connected together in order to perform the test. The output of a transmitter is directed towards the input of a receiver and the two are optically coupled using tiny fibers that connect the two together. Light is then directed from TX to RX through the fiber. If both arrays are not on the same chip, the test could still be performed, but the synchronization will be more difficult. FIG. 3 illustrates the optical interconnection of the transceiver pairs. The connection is done in the same way as in FIG. 2. An optical means, including free space or wave guide (i.e. optical fiber, fiber image guide, ordered fiber array) is used to provide the optical link between TX and RX and light is sent from one to the other.

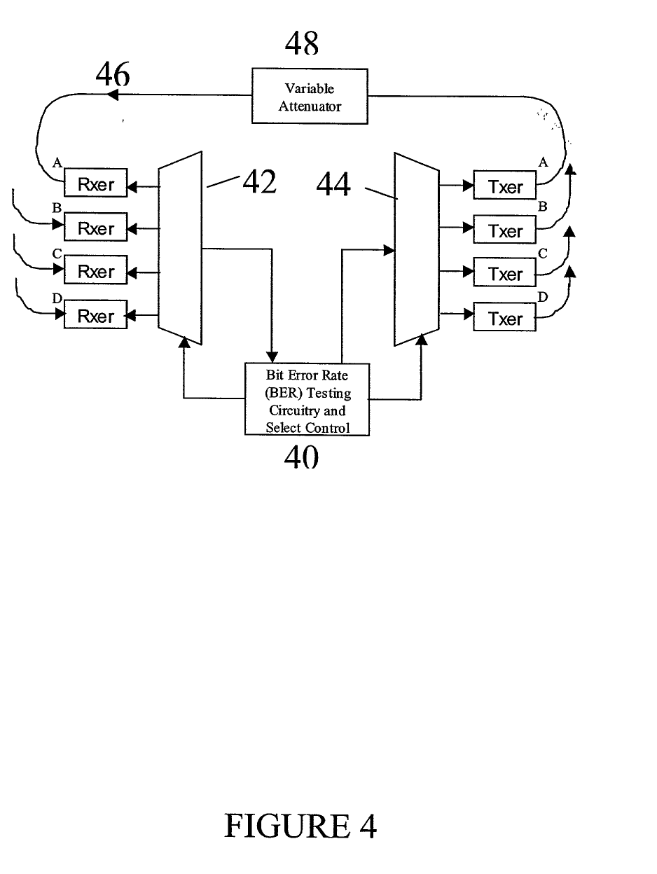

A second preferred embodiment is illustrated in FIG. 4. Using on-chip Bit Error Rate (BER) detection circuitry in conjunction with select circuitry, the performance of individual transceiver pairs can be verified “at-speed”. As is shown in FIG. 4, BER detection circuitry is connected to individual transceiver pairs A, B, C, D using control and select electronics 42, 44. The transceivers are optically interconnect 46 using any optical means which directs the output of Transmitter A to Receiver A, Transmitter B to Receiver B, etc. Examples of suitable optics include imaging optics, fiber images guides, fiber images bundles, etc. If desirable, a variable attenuator 48 can be inserted in the optical path. A known bit stream is generated by the data generation portion of the BER circuitry and sent to a selected transmitter. The transmitter sends the data to the receiver where it is read out and sent to the error detection circuitry within the BER testing block. Received data is compared to transmitted data and an error rate is computed. Using an on-chip BER tester and a variable attenuator, one can characterize the BER of a given transceiver pair as a function of operational speed, averaged received optical power, transmitter operating conditions, and receiver operating conditions. The transmitter and receiver performance could be optimized to meet a predetermined BER at a predetermined average optical power either individually or on a sub-array basis. This information could be stored in memory on the ASIC for future reference after the self-test has been completed. Upon start-up of the opto-electronic ASIC, the optimum transmitter and receiver operational points could be set once the link loss had been detected for the specific link in which the transceiver pairs were going to operate. Measurement of the link loss could be performed by initially operating the transmitter in a Continuous Wave (CW) mode and the receiver in a CW mode.

This circuitry is ideal for functional testing where the quantitative aspects as well as the qualitative aspects of a fault are detected. Several alternatives to this circuitry exist. The BER testing circuitry can output the results of the tests in a serial manner or can be connected to an accumulator with several bits that increment whenever a fault has been detected.

For both embodiments described above, there are several ways in which the test results can be read out or validated. For example, the results can be stored in memory and read off electrically at a later point in time. Real time measurements can be performed. The information can be displayed by a pattern on Light Emitting Diodes (LEDs). There could be a single pin on the chip that reads errors or ASICs can calculate the errors. In the case of the Bit Error Rate testing, the actual rate is a ratio of the amount of error bits received versus the total number of bits sent. Chips that are above or below the fixed acceptable BER rate, can then be accepted or rejected, respectively.

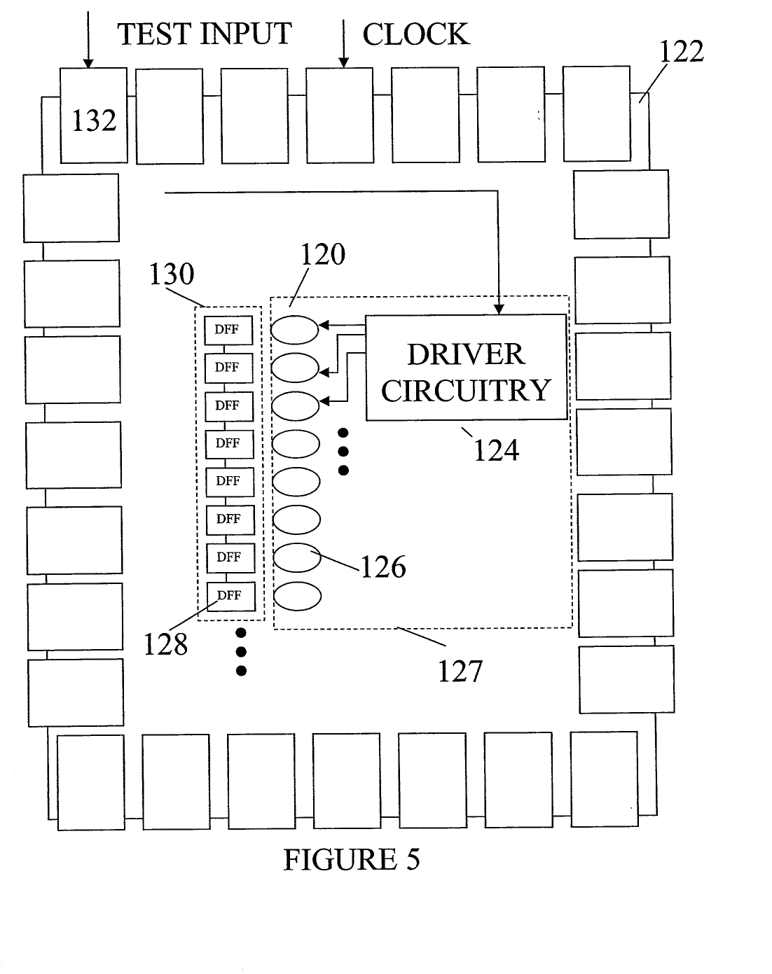

FIG. 5 illustrates the main components necessary for the testing of a large array of emitters 120. On a hybridized chip 122 where the output of the CMOS driver circuitry 124 is connected to the input of an emitter 126, it is possible to test the transmitters 127 of the chip. However, it is necessary that all emitters 120 be connectable to a memory element, such as a DFF 128. Several DFFs 128 are connected together in a scan chain 130 configuration (ratio of DFF to emitter to be tested should be 1:1), such as those used to test combinational and sequential circuits. All of the testing data is input from a single pin 132 on the chip 124. Combining the flashing emitters 120 with a visual component, such as a person looking at the lasers or an automated vision system, allows a large array of transmitters 127 to be tested in a short amount of time with little overhead circuitry. It is then possible to test if the hybridization process of the emitters 120 to the CMOS chip 122 has affected the performance of the emitter. It is also possible to verify if one emitter is imposing an error on another emitter.

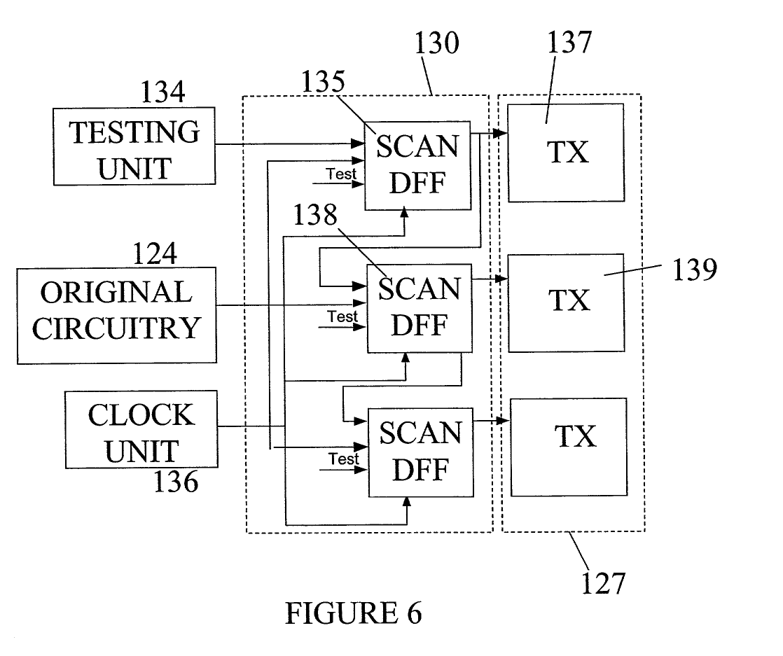

FIG. 6 illustrates the preferred embodiment for testing of a circuit with memory elements such as DFFs already present. A testing unit 134 sends out the first bit of a test vector, say 010101, to the first scan DFF 135 in the scan chain. A clocking unit 136 controls the scan DFF chain 130. On the next rising edge of the clock 136) a “1” is propagated to the output of the scan DFF 135 and sent to the emitter 137 as well as to the next scan DFF 138 in the chain. A “0” is also sent from the testing unit 134 to the scan DFF 135, On the next rising edge of the clock 136, a “0” is sent from the first scan DFF 135 to the TX/RX 137 and the second scan DFF 138. A “1” is also sent to the second laser 139 and the third scan DFF 133. A “1” is sent to scan DFF 135 from the testing unit 134. The pattern continues until the entire test vector has been sent through and an alternating pattern of ones and zeros can be seen on the lasers.

Several different patterns can be used to test the lasers. By scanning in a “000001” (assuming a six bit scan chain) across the laser chain, each laser can be lit up in turn. By scanning in a “101010” pattern, the lasers can be made to blink. If this is done as part of an array, then a checker board pattern can be created. By scanning in a “111111” pattern, all lasers can be turned on simultaneously, These different types of test vectors are useful in detecting where a fault has occurred.

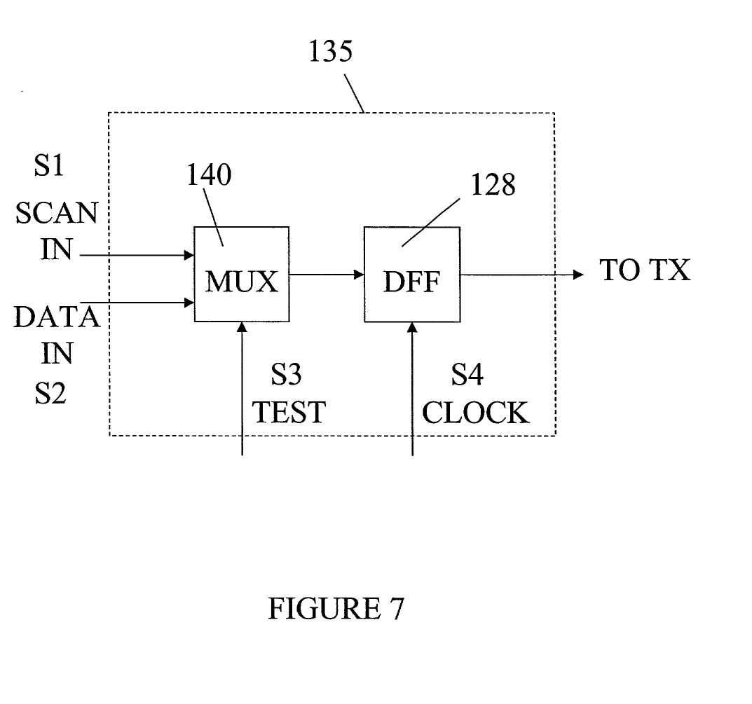

FIG. 7 demonstrates the inside of a scan DFF 135 from FIG. 6. A 2:1 multiplexor 140 is connected to the input of a DFF 128 to create a scan DFF 135. The mux performs a selection between the test vector SI, used only for testing, and the data signal S2, the data that usually runs through the circuit. The selection is done by the test signal S3, which is controlled externally. When the mux 140 is in test mode(i.e. when the test signal S3 is at 0), then the bit that appears at the scan in input S1 is sent directly to the DFF 128. The DFF 128 is controlled by a clock signal S4. On the following rising edge, the bit at the input of the DFF 128 is propagated to its output and sent to the TX/RX 137 of FIG. 6.

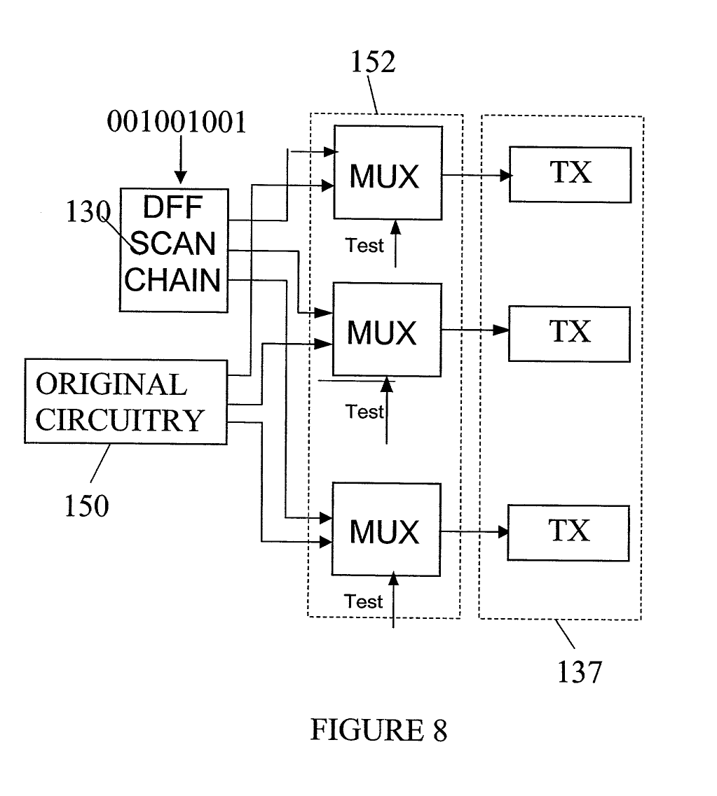

FIG. 8 is a schematic of the preferred embodiment for testing a circuit where DFFs 130 are not originally present. A chain of DFFs 130 is added in parallel to the original circuitry 150. A series of 2:1 multiplexors 152 are inserted between the output of the added chain of DFFs 130 to select between the test data and the data coming from the original circuitry 50 that fed into the TX/RX 137. When the multiplexors 152 are in test mode, they send the test data to the TX/RX 137.

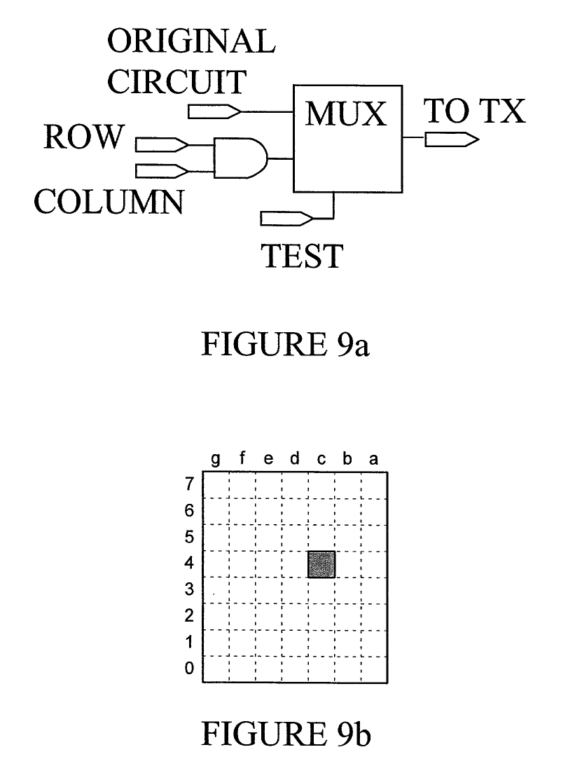

FIG. 9 demonstrates how to control a 2D array of elements by directly addressing each element individually. FIG. 9b show N×M elements arranged in a matrix configuration, N+M inputs are required to be able to address each row and column individually. In this case, no D flip flops are required. The inputs are simply connected directly to the row of elements. FIG. 9a is the circuitry used to turn on a single cell, as is seen in FIG. 9b. Two scan chains can be used as the row and column inputs to send in a an input serially. The cell with its row and column turned on is addressed. Three (3) input pads are necessary for this, two for the data and one for the clock. It is possible to reduce the number of input pads necessary to two (2) if the output of the row scan chain feeds into the input of the column scan chain, or vice versa. However, testing time increases due to the time it takes for a vector to go through an entire chain before being fed into a second chain.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

What is claimed is:

1. A method for providing a built-in test for large arrays of elements; said arrays comprising rows and columns of ones of optically coupled transmitters (TX) and receivers (RX) on integrated circuit chips; said chips comprising opto-electronic input and output ports, wherein test data can be read out in a serial or parallel manner, said method comprising:
generating said test data;
providing on-chip testing circuitry to relay test data from an input to a large number of said TX;
coupling said transmitters with said receivers so as to relay an optical signal between pairs;
receiving an optical signal at said receiver;
collecting an output of electrical signals from a large number of said RX to a single output;
analyzing said output to provide a result of said test, whereby said result is used to determine a quality of said elements.

2. A method as claimed in claim 1, wherein said built-in test is a self-test.

3. A method as claimed in claim 1, wherein said providing comprises providing said testing circuitry on silicon ASIC.

4. A method as claimed in claim 1, wherein said providing and collecting comprises selecting circuitry and further comprising a step of identifying said TX-RX pairs.

5. A method as claimed in claim 4, wherein a TX-RX pair is selected, an optical data path from said TX-RX pair is provided, and a Bit Error Rate performance is detected.

6. A method as claimed in claim 1, wherein said generating comprises an input of said test data, said providing comprises the shifting of said test data into said transmitters, said transmitting comprises sending an optical signal through an optical data path from TX to RX, said receiving consists of receiving said optical data consisting of output data, and said analyzing comprises comparing said input and output data and accumulating detected errors.

7. A method as claimed in claim 1, wherein said transmitting occurs on a first chip and said receiving occurs on a second chip.

8. A method as claimed in claim 1, wherein said analyzing occurs off-chip.

9. A method as claimed in claim 1, further comprising a step of serially inputting test data to a set of optical elements that are to be tested, said test data taking the form of a plurality of patterns facilitating visual inspection.

10. A method as claimed in claim 1, wherein said testing can be done for at least one of a single element, a single column, a single row, a group of elements, and an entire array in a simultaneous manner.

11. A circuit for a built-in test for large arrays of optically coupled transmitters (TX) and receivers (RX) on integrated circuit chips comprising opto-electronic input and output ports, said circuit comprising:
a generating unit to generate test data
a testing unit to accept said test data from said generating unit and relay it to a large number of said TX;
an optical path for an optical signal from said TX derived from said test data to be relayed to said RX;
a collecting unit to collect an output of electrical signals from a large number of said receivers to a single output;
an analyzing unit to analyze said output.

12. A circuit as claimed in claim 11, wherein said testing unit is built on silicon ASIC.

13. A circuit as claimed in claim 11, wherein said testing unit comprises an array of linear feedback shift registers to relay said test data to transmitters.

14. A circuit as claimed in claim 11, wherein said analyzing unit comprises a comparator to analyze said test data and an accumulator to accumulate errors detected by said comparator.

15. A circuit as claimed in claim 11, wherein said testing unit comprises selection circuitry to select a TX-RX pair and said analyzing unit comprises Bit Error Rate testing circuitry to detect errors.

16. A circuit as claimed in claim 11, wherein said testing unit comprises scan chain circuitry of memory elements that allows serial input of said test data to a set of optical elements that are to be tested.

17. A circuit as claimed in claim 11, wherein said collecting unit comprises scan chain circuitry of memory elements to which data is relayed from a large array of RX.

18. A circuit as claimed in claim 11, wherein said analyzing unit is off-chip.

19. A method for providing a built-in test for large arrays of elements on integrated circuit chips; said chips comprising opto-electronic input and output ports, wherein testing of said elements is done in parallel and test data can be read out in a serial or parallel manner, said method comprising:
generating said test data;
providing on-chip testing circuitry to relay test data from an input to a large number of said elements;
visually assessing the output of said elements.
analyzing said output to provide a result of said test, whereby said result is used to determine a quality of said elements.

20. A method as claimed in claim 19, wherein said providing is done in a manner that makes recognition of a faulty element easy.

21. A method as claimed in claim 19, wherein said providing can be done for at least one of a single element, a single column, a single row, a group of elements, and an entire array in a simultaneous manner.

22. A method as claimed in claim 19, wherein said test data consists of a checkerboard pattern which can be shifted to cover said array of elements.
